(19) United States
(12) Patent Application Publication
(10) Pub. No.: US 2007/0206123 A1
(43) Pub. Date: Sep. 6, 2007

(54) LIQUID CRYSTAL TELEVISION

(75) Inventors: Wei-Hsin Hsieh, Tainan (TW); Chih-Kuang Tai, Tainan (TW); Yao-Tsung Ko, Tainan (TW); Chih Hung Liu, Tainan (TW); Yea-Jye Hou, Tainan (TW)

Correspondence Address: LINER YANKELEVITZ SUNSHINE AND REGENSTREIF, 1100 GLENDON AVENUE, 14TH FLOOR, LOS ANGELES, CA, 90024, US

(73) Assignee: DIGIMEDIA TECHNOLOGY CO., LTD., Taipei Hsien (TW)

(21) Appl. No.: 11/427,967

(22) Filed: Jun. 30, 2006

(30) Foreign Application Priority Data
Mar. 6, 2006 (TW) 095107429

(51) Int. Cl. H04N 5/64

(52) U.S. Cl. 348/794

(57) ABSTRACT

A liquid crystal television includes a base unit, a rear cover, a support member, an audiovisual circuit unit, and an audiovisual output unit. The rear cover is coupled to and is disposed on top of the base unit, and has an inner cover surface that confines a cover space. The support member is received in the cover space and is disposed to lie against the inner cover surface of the rear cover. The support member includes a main wall, and a flange extending from a periphery of the main wall and cooperating with the main wall to define a compartment for mounting of the audiovisual circuit unit therein. The audiovisual output unit is disposed forwardly of the audiovisual circuit unit, is secured to the flange of the support member, and includes a display panel and a speaker that are connected electrically to the audiovisual circuit unit.

### CROSS-REFERENCE TO RELATED APPLICATION

This application claims priority of Taiwanese Application No. 095107429, filed on Mar. 6, 2006.

### BACKGROUND OF THE INVENTION

1. Field of the Invention

The invention relates to a television, more particularly to a liquid crystal television

2. Description of the Related Art

As shown in FIG. 1, a conventional liquid crystal television includes a base unit 11, a rear cover 12 coupled to and disposed on top of the base unit 11, a metal support member 13 disposed in front of the rear cover 12, an audiovisual circuit unit 14 mounted to a back surface of the support member 13 and disposed between the rear cover 12 and the support member 13, an audiovisual output unit 15 disposed forwardly of the support member 13, and a front covering frame 16 disposed forwardly of the audiovisual output unit 15 and attached to a front rim of the rear cover 12.

The base unit 11 includes a metal base platform 111, a plastic support seat 113 mounted to and extending upwardly of the base platform 111, and a metal coupling plate 112 coupled to the support seat 113 and extending into the rear cover 12 so as to be coupled to the support member 13. The audiovisual output unit 15 includes a liquid crystal panel 151.

Since the audiovisual circuit unit 14 is mounted to the back surface of the support member 13 and is disposed forwardly of the rear cover 12, it is required for the rear cover 12 and the support member 13 to define a space therebetween, resulting in a relatively thick and bulky conventional liquid crystal television. Moreover, the support member 13 is made from a metal plate, and its length and width are approximately equal to those of the liquid crystal panel 151. Since the support member 13, and the base platform 111 and the coupling plate 112 of the base unit 11 are all made of metal, the conventional liquid crystal television is relatively heavy after assembly, thereby increasing manufacturing and transport costs.

### SUMMARY OF THE INVENTION

Therefore, the object of the present invention is to provide a liquid crystal television that has reduced thickness, size, weight, and manufacturing and transport costs as compared to the prior art.

According to the present invention, there is provided a liquid crystal television that includes a base unit, a rear cover, a support member, an audiovisual circuit unit, and an audiovisual output unit. The rear cover is coupled to and is disposed on top of the base unit. The rear cover has an inner cover surface that confines a cover space. The support member is received in the cover space and is disposed to lie against the inner cover surface of the rear cover. The support member includes a main wall, and a flange extending from a periphery of the main wall and cooperating with the main wall to define a compartment. The audiovisual circuit unit is mounted in the compartment of the support member. The audiovisual output unit includes a display panel and a speaker that are connected electrically to the audiovisual circuit unit. The audiovisual output unit is disposed forwardly of the audiovisual circuit unit and is secured to the flange of the support member.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional liquid crystal television;

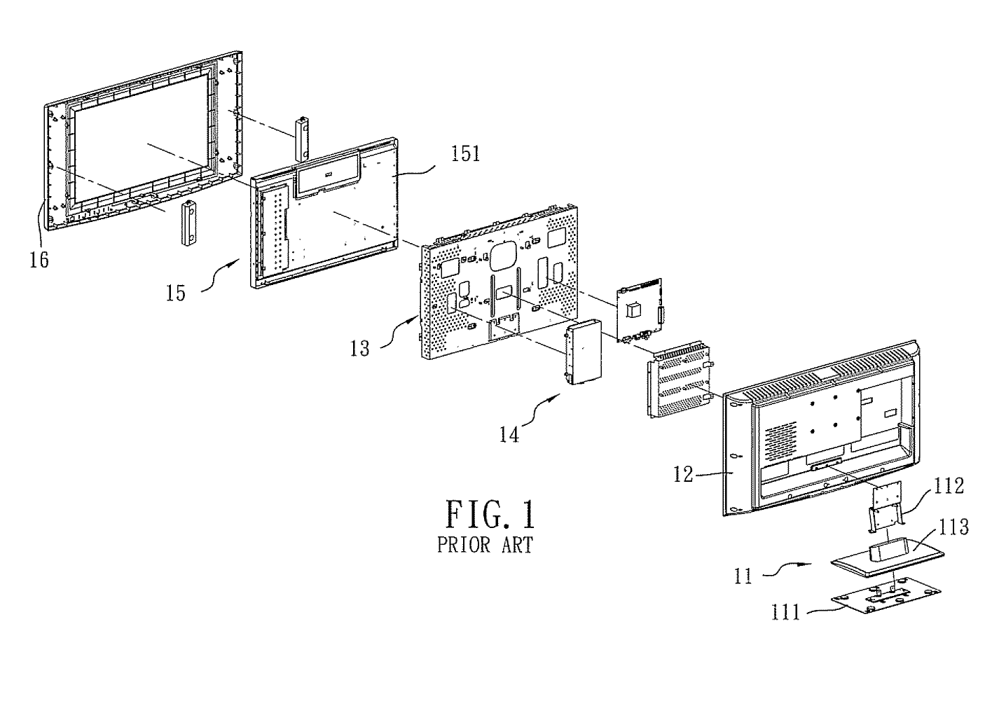

FIG. 2 is an assembled perspective view of the preferred embodiment of a liquid crystal television according to the present invention;

FIG. 3 is an exploded perspective view of the preferred embodiment;

FIG. 4 is an enlarged fragmentary perspective view of a base unit and a rear cover of the preferred embodiment; and

FIG. 5 is a sectional view of the preferred embodiment

### DETAILED DESCRIPTION OF THE PREFERRED EMBODIMENT

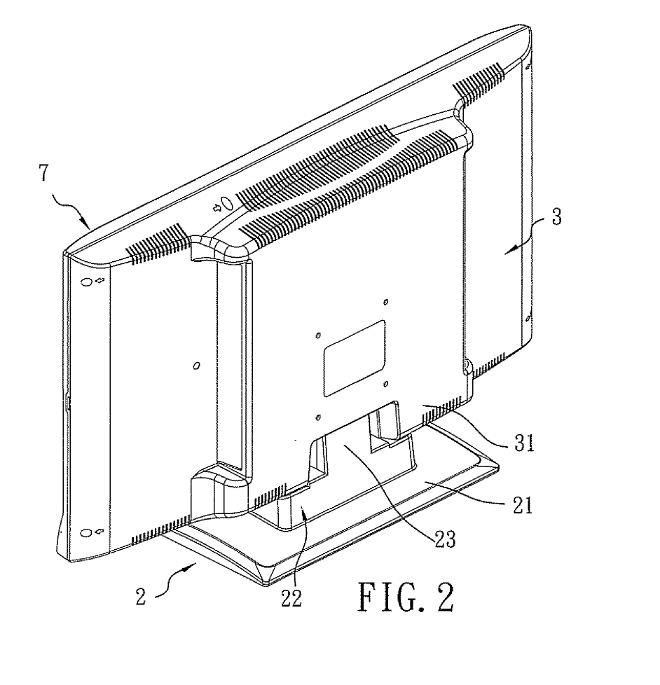

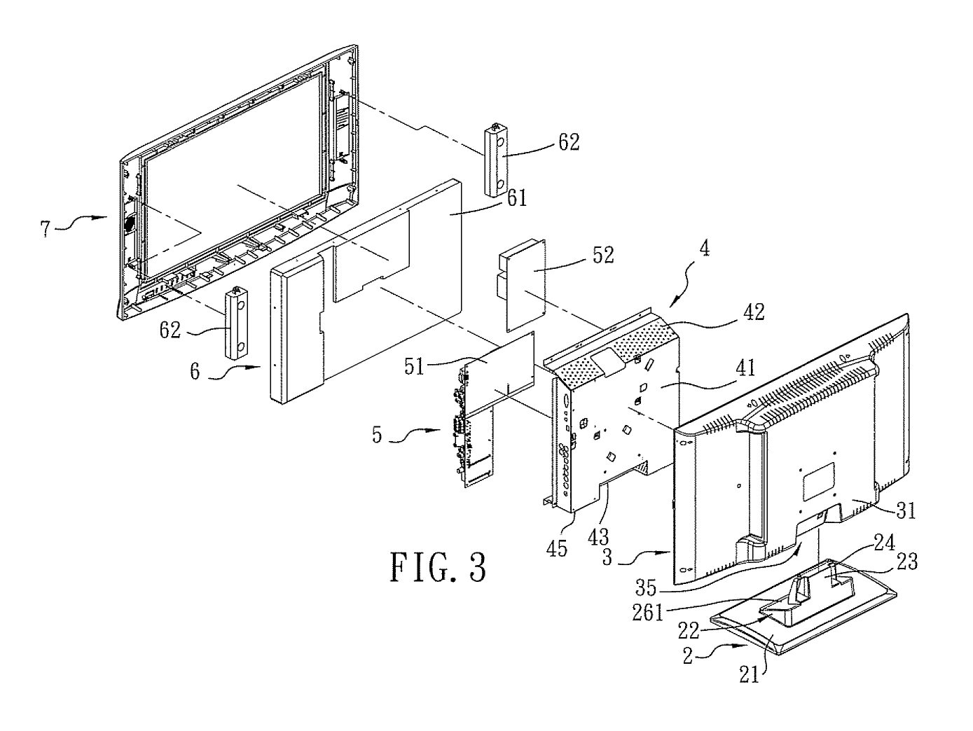

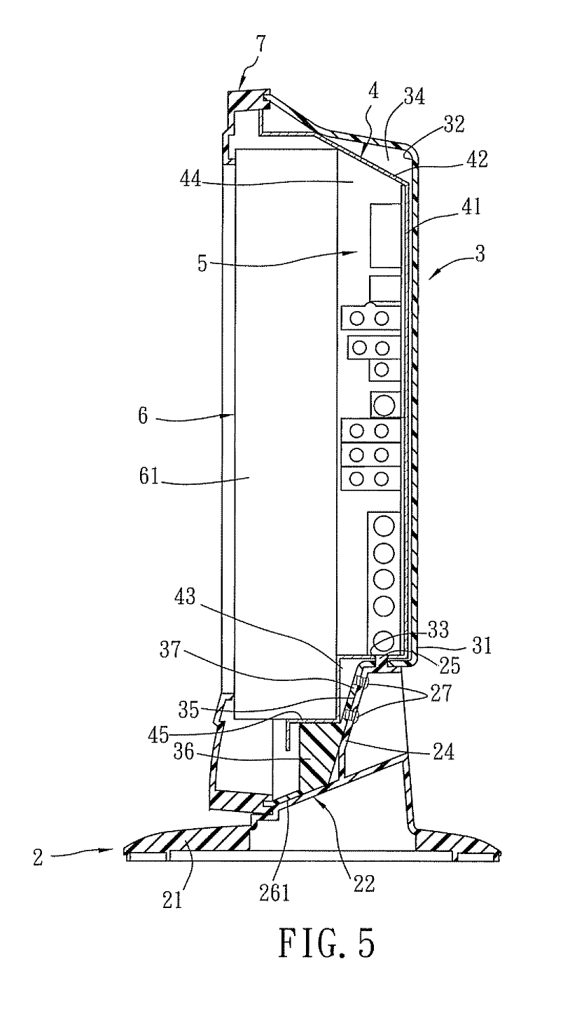

As shown in FIG. 2, FIG. 3 and FIG. 5, the preferred embodiment of a liquid crystal television according to the present invention includes a base unit 2, a rear cover 3, a support member 4, an audiovisual circuit unit 5, an audiovisual output unit 6, and a front covering frame 7. The rear cover 3 is coupled to and is disposed on top of the base unit 2, and has an inner cover surface 32 that confines a cover space 34. The support member 4 is received in the cover space 34 and is disposed to lie against the inner cover surface 32 of the rear cover 3. The support member 4 includes a main wall 41, and a flange 42 extending from a periphery of the main wall 41 and cooperating with the mainwall 41 to define a compartment 44. The audiovisual circuit unit 5 is mounted in the compartment 44 of the support member 4. The audiovisual output unit 6 includes a liquid crystal display panel 61 and two speakers 62 that are connected electrically to the audiovisual circuit unit 5. The audiovisual output unit 6 is disposed forwardly of the audiovisual circuit unit 5 and is secured to the flange 42 of the support member 4 The front covering frame 7 covers a front peripheral edge of the display panel 61, and is attached to a front rim of the rear cover 3.

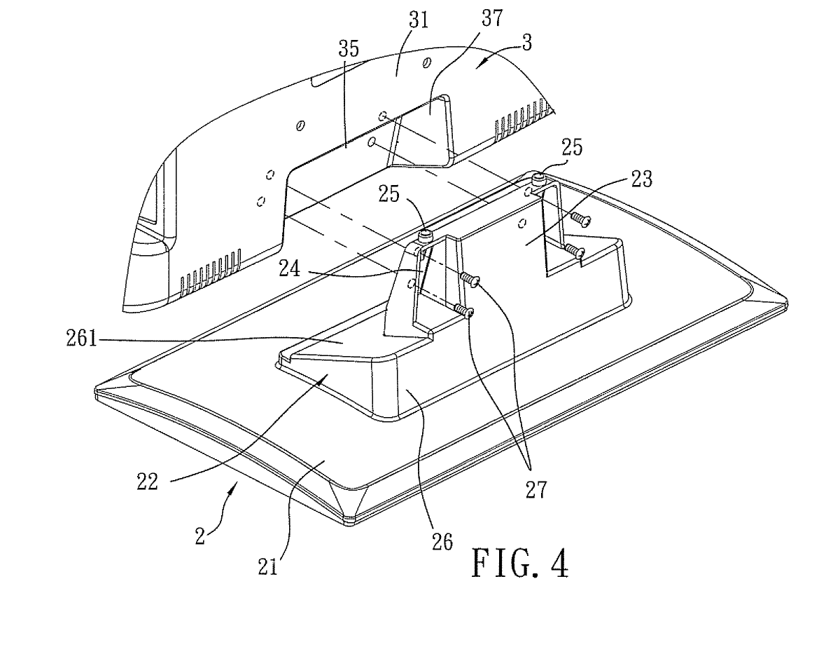

With further reference to FIG. 4, the base unit 2 includes abase platform 21, and a support seat 22 extending upwardly from the base platform 21. The support seat 22 has an upper coupling part 23, and is formed with a pair of lateral wing plates 24 that are disposed on opposite lateral sides of the upper coupling part 23. The upper coupling part 23 has a top end formed with two upwardly projecting pins 25. The support seat 22 further includes a lower support part 26 between the upper coupling part 23 and the base platform 21 The lower support part 26 has an inclined surface 261 that extends forwardly and downwardly from the upper coupling part 23. In this embodiment, the base unit 2 is formed integrally by plastic injection molding.

The rear cover 3 is made of a plastic materials and includes a bottom cover part 31 formed with a notch 35 for receiving the upper coupling part 23 of the support seat 22 therein. In particular, the bottom cover part 31 has a notch defining wall 37 (see FIG. 5) that defines the notch 35 and that projects into the cover space 34. The bottom cover part 31 is further formed with two pin holes 33 (only one is visible in FIG. 5) in spatial communication with the notch 35 and respectively engaging the pins 25 of the upper coupling part 23 of the support seat 22 when the upper coupling part 23 is received in the notch 35. The bottom cover part 31 is further formed with an abutting block 36 that projects into the cover space 34.

The inclined surface 261 of the lower support part 26 of the support seat 22 supports the bottom cover part 31 of the rear cover 3 thereon when the upper coupling part 31 is received in the notch 35. In particular, a bottom side of the abutting block 36 abuts against the inclined surface 261 of the lower support part 26 of the support seat 22 when the upper coupling part 23 is received in the notch 35 in the bottom cover part 31.

In this embodiment, the wing plates 24 of the support seat 22 abut against the rear cover 3 when the upper coupling part 23 is received in the notch 35. The base unit 2 further includes a set of screw fasteners 27 for fastening the wing plates 24 to the rear cover 3 when the upper coupling part 23 is received in the notch 35.

The support member 4 includes the main wall 41 and the flange 42, and is made by punching a metal material. The main wall 41 is formed with a cavity 43 to receive the notch defining wall 37 of the bottom cover part 31 of the rear cover 3 The flange 42 includes a bottom flange part 45 In this embodiment, the cavity 43 corresponds in shape to the notch defining wall 37 such that the bottom flange part 45 is seated on top of the abutting block 36, and such that the support member 4 is received fittingly in the cover space 34 in the rear cover 3. The flange 42 is coupled to the front covering frame 7.

The audiovisual circuit unit 5 is mounted in the compartment 44 of the support member 4, and includes an audiovisual circuit 51 for outputting audio and video signals respectively to the speakers 62 and the display panel 61 of the audiovisual output unit 6, and a power circuit 52 connected electrically to the audiovisual circuit 51 and the audiovisual output unit 6 for supplying electrical power thereto.

The display panel 61 of the audiovisual output unit 6 is secured to the flange 42 of the support member 4, and has a width larger than that of the support member 4 such that the display panel 61 has opposite lateral parts that extend beyond opposite lateral edges of the support member 4, respectively. The speakers 62 are disposed beside the opposite lateral parts of the display panel 61. In this embodiment, the width of the support member 4 is half of that of the display panel 61. Since the audiovisual circuit unit 5 and the audiovisual output unit 6 are not where the feature of the present invention resides, further details of the same are omitted herein for the sake of brevity.

To assemble the liquid crystal television, the audiovisual circuit unit 5 is first mounted in the compartment 44 in the support member 4 using screw fasteners (not shown), and the display panel 61 of the audiovisual output unit 6 is then secured to the flange 42 of the support member 4 using screw fasteners (not shown). Subsequently, the flange 42 is hooked onto the front covering frame 7 such that the front covering frame 7 covers the front peripheral edge of the display panel 61 Next, the speakers 62 are disposed beside the opposite lateral parts of the display panel 61 and are hooked on the front covering frame 7. Note that mounting of the flange 42 and the speakers 62 to the front covering frame 7 can also be done using screw fasteners. The support member 4 is received in the cover space 34 in the rear cover 3, and the notch defining wall 37 of the bottom cover part 31 of the rear cover 3 is received in the cavity 43 in the support member 4. Next, the front covering frame 7 and the front rim of the rear cover 3 are attached to each other using screw fasteners (not shown). Subsequently, the rear cover 3 is disposed on top of the base unit 2, and is coupled to the base unit 2. At this time, the upper coupling part 23 and the wing plates 24 of the support seat 22 of the base unit 2 are received in the notch 35 in the bottom cover part 31 of the rear cover 3, the pins 25 engage the pin holes 33 in the bottom cover part 31, and the abutting block 36 of the bottom cover part 31 is supported on the inclined surface 261 of the lower support part 26 of the support seat 22. Finally, the wing plates 24 are fastened to the notch defining wall 37 of the rear cover 3 using the screw fasteners 27. Consequently, the front covering frame 7, the audiovisual output unit 6, the audiovisual circuit unit 5, the support member 4 and the rear cover 3 are altogether mounted to and disposed on top of the base unit 2.

After assembly, since the audiovisual circuit unit 5 is mounted in the compartment 44 in the support member 4, the thickness, and thus the size, of the liquid crystal television is reduced as compared to the prior art. In addition, since the width of the support member 4 is only half of that of the display panel 61, the weight of the liquid crystal television is also reduced

It should be noted herein that since the abutting block 36 of the bottom cover part 31 abuts against the inclined surface 261 of the lower support part 26 of the support seat 22 after assembly, the abutting block 36 and the lower support part 26 help support the weight of other components disposed there above such that the upper coupling part 23 is not relied upon to bear most of the weight. Moreover, since the base unit 2 is made by plastic injection molding, it is easy to manufacture and is low in cost.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A liquid crystal television comprising:
a base unit;
a rear cover coupled to and disposed on top of said base unit, said rear cover having an inner cover surface that confines a cover space;
a support member received in said cover space and disposed to lie against said inner cover surface of said rear cover, said support member including a main wall, and a flange extending from a periphery of said main wall and cooperating with said main wall to define a compartment; an audiovisual circuit unit mounted in said compartment of said support member; and
an audiovisual output unit including a display panel and a speaker that are connected electrically to said audiovisual circuit unit, said audiovisual output unit being disposed forwardly of said audiovisual circuit unit and being secured to said flange of said support member.

2. The liquid crystal television as claimed in claim 1, wherein:
said base unit includes a base platform, and a support seat extending upwardly from said base platform, said support seat having an upper coupling part; and
said rear cover includes a bottom cover part formed with a notch for receiving said upper coupling part of said support seat therein.

3. The liquid crystal television as claimed in claim 2, wherein said support seat of said base unit is formed with a pair of lateral wing plates that are disposed on opposite lateral sides of said upper coupling part and that abut against said rear cover when said upper coupling part is received in said notch; and
wherein said upper coupling part has a top end formed with at least one upwardly projecting pin, said bottom cover part of said rear cover being formed with at least one pin hole in spatial communication with said notch and engaging said pin when said upper coupling part is received in said notch.

4. The liquid crystal television as claimed in claim 3, wherein said base unit further includes a set of screw fasteners for fastening said wing plates to said rear cover.

5. The liquid crystal television as claimed in claim 2, wherein said support seat of said base unit further includes a lower support part between said upper coupling part and said base platform, said lower support part having an inclined surface that extends forwardly and downwardly from said upper coupling part and that supports said bottom cover part of said rear cover thereon when said upper coupling part is received in said notch.

6. The liquid crystal television as claimed in claim 2, wherein said bottom cover part of said rear cover has a notch defining wall that defines said notch and that projects into said cover space, said support member being further formed with a cavity to receive said notch defining wall of said bottom cover part of said rear cover.

7. The liquid crystal television as claimed in claim 1, wherein said audiovisual circuit unit includes an audiovisual circuit for outputting audio and video signals respectively to said speaker and said display panel of said audiovisual output unit, and a power circuit connected electrically to said audiovisual circuit and said audiovisual output unit for supplying electrical power thereto.

8. The liquid crystal television as claimed in claim 2, wherein said base unit is formed integrally.

9. The liquid crystal television as claimed in claim 8, wherein said base unit is formed integrally by plastic injection molding.

10. The liquid crystal television as claimed in claim 1, wherein said support member has a width smaller than that of said display panel of said audiovisual output unit such that said display panel has opposite lateral parts that extend beyond opposite lateral edges of said support member, respectively.

11. The liquid crystal television as claimed in claim 10, wherein the width of said support member is half of that of said display panel.

12. The liquid crystal television as claimed in claim 2, wherein said bottom cover part of said rear cover is formed with an abutting block that projects into said cover space, said flange of said support member including a bottom flange part that is seated on top of said abutting block.

13. The liquid crystal television as claimed in claim 1, further comprising a front covering frame for covering a front peripheral edge of said display panel.

14. The liquid crystal television as claimed in claim 13, wherein said flange of said support member is coupled to said front covering frame.

15. The liquid crystal television as claimed in claim 13, wherein said front covering frame is attached to a front rim of said rear cover.
